(19) United States
(12) Patent Application Publication
(10) Pub. No.: US 2026/0311913 A1
(43) Pub. Date: Oct. 8, 2026

(54) CYCLONIC FLOW, LIQUID COOLED BRAKE RESISTOR WITH MULTIPLE NESTED RESISTOR COILS

(71) Applicant: DRS Naval Power Systems, Inc., Menomonee Falls, WI (US)

(72) Inventors: Michael Wadzinski, Colgate, WI (US); Michael Krause, Dousman, WI (US); Ryan Kee, Milwaukee, WI (US)

(73) Assignee: DRS Naval Power Systems, Inc., Menomonee Falls, WI (US)

(21) Appl. No.: 19/638,901

(22) Filed: Apr. 3, 2026

Related U.S. Application Data
(60) Provisional application No. 63/783,743, filed on Apr. 4, 2025.

(51) Int. Cl. H01C 1/082; H01C 7/22

(52) U.S. Cl. CPC H01C 1/082; H01C 7/22

(57) ABSTRACT

A resistor structure includes a housing having a first end, a second end, and an intermediate portion therebetween. The intermediate portion includes a proximal end connected to the first end and a distal end connected to the second end. The resistor structure also includes a first helical resistor element positioned inside the housing and having a first input electrical terminal and a first output electrical terminal, a retention cover at least partially enclosing the first end, and a base cover at least partially enclosing the second end. The resistor structure also includes a first opening in the retention cover, where the first input electrical terminal axially protrudes out of the first opening. The resistor structure also includes a second opening in the base cover, where the first output electrical terminal tangentially protrudes out of the second opening.

### CROSS-REFERENCES TO RELATED APPLICATIONS

This application claims the benefit of and priority to U.S. Provisional Patent Application No. 63/783,743, filed Apr. 4, 2025, entitled “CYCLONIC FLOW, LIQUID COOLED BRAKE RESISTOR WITH MULTIPLE NESTED RESISTOR COILS, the disclosure of which is hereby incorporated by reference in its entirety for all purposes.

### BACKGROUND OF THE INVENTION

Electrical components, such as resistors, can be used to dissipate excess electrical energy in the form of heat through the principle of resistance. Such resistors are widely used in a variety of industrial and/or transportation applications incorporating electric motors. One example application includes using the excess electrical energy generated by an electric motor for regenerative braking in the context of electric vehicles (EVs). When the EV slows down, the electric motor can act as a generator, converting the vehicle's kinetic energy into electrical energy. While a significant portion of this energy is typically redirected back into the battery through the regenerative braking process, any surplus electrical energy that cannot be stored by the battery must be diverted away from the motor and battery system to prevent damage to these components, for example, using a brake resistor.

Despite progress made in the field of electric motors and brake resistors, there is a need in the art for improved brake resistors.

### SUMMARY OF THE INVENTION

Embodiments of the present invention relate generally to resistor structures for dissipating excess energy in the form of heat. More particularly, the present invention relates to a cyclonic flow, liquid cooled dynamic brake resistor (DBR) having multiple nested coils. Example applications for the present disclosure include electric or hybrid-electric vehicles (including marine vehicles or industrial drives) utilizing regenerative braking systems, cranes and hoists, wind turbines, industrial drives and motors, elevators and escalators, and the like. Embodiments of the present invention provide improved power density without unduly increasing the physical footprint of the brake resistor, especially in applications where size and space are premium considerations. Although portions of the present disclosure are described in reference to electric machines, the disclosure is applicable to a variety of industrial and/or transportation applications where managing excess electrical energy and preventing damage to system components is of

According to an aspect of the disclosure, a resistor structure can include a housing including a first end, a second end, and an intermediate portion therebetween, the intermediate portion including a proximal end connected to the first end and a distal end connected to the second end. The resistor structure can include a first helical resistor element positioned inside the housing and having a first input electrical terminal and a first output electrical terminal. The resistor structure can include a second helical resistor element nested within the first helical resistor element and having a second input electrical terminal and a second output electrical terminal. The resistor structure can include a retention cover at least partially enclosing the first end and a base cover at least partially enclosing the second end. The resistor structure can include a plurality of laterally offset openings in the retention cover, where the first input electrical terminal protrudes out of a first laterally offset opening of the plurality of laterally offset openings and the second input electrical terminal protrudes out of a second laterally offset opening of the plurality of laterally offset openings. The resistor structure can include a plurality of circumferentially offset openings in the base cover, where the first output electrical terminal protrudes out of a first circumferentially offset opening of the plurality of circumferentially offset openings and the second output electrical terminal protrudes out of a second circumferentially offset opening of the plurality of circumferentially offset openings.

In various embodiments, the first output electrical terminal and the second output electrical terminal can be circumferentially offset by 180°.

In various embodiments, the first helical resistor element and the second helical resistor element can form a spiral structure having a central axis running through a center of the spiral structure and the resistor structure can include an inlet port formed in the proximal end of the intermediate portion, where the inlet port can be configured to receive a cooling liquid. The resistor structure can include an outlet port formed in a bottom side of the base cover, where the outlet port is configured to expel the cooling liquid. The resistor structure can include a flow diverter positioned along the central axis and inside the spiral structure, the flow diverter having a length substantially corresponding to a length of the intermediate portion. In some embodiments, the outlet port can be aligned with the central axis of the spiral structure. In some embodiments, the flow diverter can include a plurality of exit openings positioned in a bottom portion of the flow diverter and can be configured to allow the cooling liquid to flow out of the outlet port. In some embodiments, the flow diverter can be hollow.

In various embodiments, the first helical resistor element and the second helical resistor element can be electrically connected in parallel.

In various embodiments, the first helical resistor element includes a first plurality of resistor coils and the second helical resistor element includes a second plurality of resistor coils, where the first plurality of resistor coils and the second plurality of resistor coils are separated by a uniform spacing.

In various embodiments, the resistor structure includes a third helical resistor element nested within the first helical resistor element and the second helical resistor element and having a third input electrical terminal and a third output electrical terminal. In some embodiments, the third input electrical terminal can protrude out of a third laterally offset opening, and the third output electrical terminal can protrude out of a third circumferentially offset opening. In some embodiments, the first output electrical terminal, the second output electrical terminal, and the third output electrical terminal can be circumferentially offset by 120°. In some embodiments, the resistor structure can be electrical coupled to a three-phase electric motor, where the first helical resistor element, the second helical resistor element, and the third helical resistor element each corresponds to a single phase of the three-phase electric motor, respectively. In some embodiments, the first helical resistor element, the second helical resistor element, and the third helical resistor element can be electrically connected in parallel.

In various embodiments, the resistor structure can include a support ring positioned around the first helical resistor element and the second helical resistor element and coupled to the base cover. The support ring can be configured to support the first output electrical terminal protruding out of the first circumferentially offset opening and the second output electrical terminal protruding out of the second circumferentially offset opening.

According to another aspect of the disclosure, a resistor structure can include a housing having a first end, a second end, and an intermediate portion therebetween. The intermediate portion can include a proximal end connected to the first end and a distal end connected to the second end. The resistor structure can also include a first helical resistor element positioned inside the housing and having a first input electrical terminal and a first output electrical terminal, a retention cover at least partially enclosing the first end, and a base cover at least partially enclosing the second end. The resistor structure can also include a first opening in the retention cover, where the first input electrical terminal axially protrudes out of the first opening. The resistor structure can also include a second opening in the base cover, where the first output electrical terminal tangentially protrudes out of the second opening.

According to yet another aspect of the disclosure, a method of cooling a spiral resistor structure can include providing a structure. The structure can include a housing having an inlet port on a side portion of the housing and an outlet port on a bottom portion of the housing, a first helical resistor element positioned inside the housing and having a first input electrical terminal and a first output electrical terminal, and a second helical resistor element positioned inside the housing and nested inside the first helical resistor element to thereby form the spiral resistor structure. The second helical resistor element can have a second input electrical terminal and a second output electrical terminal. The method can include flowing a first electrical current through the first input electrical terminal to the first output electrical terminal. The method can include flowing a second electrical current through the second input electrical terminal to the second output electrical terminal. The method can include flowing a cooling liquid into the housing through the inlet port and absorbing, by the cooling liquid, heat generated by the spiral resistor structure. The method can include routing the cooling liquid out of the housing through the outlet port.

In various embodiments, the method can include circulating the cooling liquid around a cyclonic flow channel formed in a space between an outer portion of the spiral resistor structure and an inner sidewall portion of the housing.

In various embodiments, a central axis can be defined through a center of the spiral resistor structure, and the method can include increasing a heat transfer between the spiral resistor structure and the cooling liquid using a flow diverter positioned along the central axis.

In various embodiments, the first helical resistor element can include a first plurality of resistor coils and the second helical resistor element includes a second plurality of resistor coils, where the first plurality of resistor coils and the second plurality of resistor coils are separated by a uniform spacing.

In various embodiments, the cooling liquid can comprise water.

In various embodiments, the first helical resistor element and the second helical resistor element can be electrically connected in parallel.

According to yet another aspect of the disclosure, a method of forming a cyclonic flow, liquid cooled DBR is provided. The method can include providing a first helical resistor element having a first input electrical terminal and a first output electrical terminal, providing a second helical resistor element having a second input electrical terminal and a second output electrical terminal, and nesting the first helical resistor element within the second helical resistor element thereby forming a spiral resistor structure. The method can also include enclosing the spiral resistor structure using a housing having a first end and a second end, wherein at least one of the first end or the second end comprises a base cover and a support ring, wherein the base cover comprises a plurality of circumferentially disposed holes, and wherein a circular channel connecting the plurality of circumferentially disposed holes is formed around the base cover between the base cover and the support ring, flowing a molten filler material via the circular channel to distribute the molten filler material into the plurality of circumferentially disposed holes, and cooling the DBR to seal base cover to the support ring. In some embodiments, the molten filler material comprises a metallic molten filler material and in other embodiments, the molten filler material comprises a non-metallic molten filler material. In some embodiments, the plurality of circumferentially disposed holes comprises a plurality of brazing holes and a plurality of riser holes, wherein the first output electrical terminal and the second output electrical terminal extend through the support ring and are accessible outside the DBR, wherein a first riser hole of the plurality of riser holes is positioned between a portion of the first helical resistor element and the support ring, and wherein a second riser hole of the plurality of riser holes is positioned between a portion of the second helical resistor element and the support ring.

Numerous benefits are achieved by way of the present disclosure over conventional techniques. For example, embodiments of the present invention provide DBRs that are characterized by a lower resistor tube surface temperature rise while providing four times (or more) the power dissipation capacity compared to conventional devices. Moreover, embodiments of the present invention provide a resistor tube area that is twice the area of devices characterized by the same device volume. As a result, embodiments of the present invention reduce the number and severity of resistor tube hot spots.

Conventional DBR designs typically rely on a “single-sided” configuration in which input and output electrical terminals are positioned on the same side of the DBR housing. In such conventional designs, the resistors tubes are typically “U-shaped,” where the input electrical terminal and output electrical terminal are accessible at a first end of the DBR housing, and the resistor coil(s) extends down into the DBR housing and loops back to the first end of the DBR housing, thereby forming a U-shape resistor tube inside the DBR housing. In contrast, some embodiments of the present invention provide DBRs having a “double-sided” configuration, in which electrical terminals of the resistor structure are accessible (e.g., protrude outwards) at opposing ends of the housing (e.g., the canister) of the DBR and having differing orientations (e.g., axial orientation at one end and tangential orientation at the other end). In addition, embodiments of the present invention provide DBRs that utilize nested helical resistor structures inside the DBR housing as opposed to the U-shaped tubes of conventional designs.

The double-sided configuration, including the differing orientations of the electrical terminals and spiral resistor structures, provide numerous benefits over conventional techniques such as improved cooling and improved power dissipation ratings for the same housing/canister volume. According to one particular example, a conventional DBR utilizing U-shaped resistor tubes in a single-sided configuration may be rated for 12 kilowatts (kW) of power dissipation. The power dissipation rating for such a DBR is typically limited by the severity and number of hot spots on the resistor tubes. The inventors have determined that using the conventional U-shaped resistor tubes in a single-sided configuration leads to a range of hot spot temperatures on the resistor tube tubes between about 515 °F to about 630 °F. In contrast, embodiments of the present invention having a double-sided configuration can about quadruple the power dissipation rating to 47 kW (due to an increase in resistor tube area by virtue of the spiral resistor structure) and still achieve lower ranges of hot spot temperatures on the resistor tube coils between about 400 °F to 475 °F (due to improved cooling by virtue of improved fluid dynamics resulting from the spiral resistor structure). These and other embodiments of the disclosure, along with many of its advantages and features, are described in more detail in conjunction with the text below and corresponding figures.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

The included drawings are for illustrative purposes and serve only to provide examples of possible structures and arrangements for the disclosed inventive apparatuses and methods for cyclonic flow, liquid cooled dynamic brake resistors (DBRs). These drawings in no way limit any changes in form and detail that may be made to the disclosure by one skilled in the art without departing from the spirit and scope of the disclosure. The embodiments will be readily understood by the following detailed description in conjunction with the accompanying drawings, wherein like reference numerals designate like structural elements, and in which:

FIG. 1 illustrates an exemplary cyclonic flow, liquid cooled DBR according to an embodiment of the present disclosure.

FIG. 2 illustrates another exemplary cyclonic flow, liquid cooled DBR according to an embodiment of the present disclosure.

FIG. 3A illustrates a perspective view of a first helical resistor coil according to an embodiment of the present disclosure.

FIG. 3B illustrates a perspective view of a second helical resistor coil nested within the first helical resistor coil of FIG. 3A according to an embodiment of the present disclosure.

FIG. 3C illustrates a perspective view of a third helical resistor coil nested within the first helical resistor coil and the second helical resistor coil of FIG. 3B according to an embodiment of the present disclosure.

FIG. 3D illustrates a perspective view of the spiral resistor structure of FIG. 3C coupled to a base cover and having a support ring according to an embodiment of the present disclosure FIG. 3E illustrates a perspective view of spiral resistor structure of FIG. 3D with a retention cover according to an embodiment of the present disclosure.

FIG. 3F is a perspective view of the retention cover of FIG. 3E and electrical terminals according to an embodiment of the present disclosure.

FIG. 3G illustrates a perspective view of the spiral resistor structure of FIG. 3E with a housing according to an embodiment of the present disclosure.

FIG. 4 illustrates a first perspective view of a base cover and support ring for a spiral resistor structure according to an embodiment of the present disclosure.

FIG. 5 illustrates a second perspective view of a base cover and support ring for a spiral resistor structure according to an embodiment of the present disclosure.

FIG. 6A is a perspective view of a flow diverter according to an embodiment of the present disclosure.

FIG. 6B illustrates a cross-sectional view of an exemplary cyclonic flow, liquid cooled DBR including a flow diverter according to an embodiment of the present disclosure.

FIG. 6C illustrates an enlarged cross-sectional view of the exemplary cyclonic flow, liquid cooled DBR of FIG. 6B, according to an embodiment of the present disclosure.

FIG. 7 illustrates an exemplary flowchart illustrating a process of cooling a spiral resistor structure according to an embodiment of the present disclosure.

FIG. 8 illustrates an exemplary voltage divider circuit according to an embodiment of the present disclosure.

FIG. 9 illustrates an exemplary flowchart illustrating a process of forming a cyclonic flow, liquid cooled DBR according to an embodiment of the present disclosure.

### DETAILED DESCRIPTION OF SPECIFIC EMBODIMENTS

Electric motors used in industrial and/or transportation applications can generate excess electrical energy. DBRs are typically used in such applications to dissipate the excess electrical energy as heat, thereby increasing system stability and safety. For instance, and according to one particular example, DBRs may be used in EV systems incorporating regenerative braking functionality. When an EV slows down, the electric motor acts as a generator, converting the vehicle's kinetic energy into electrical energy. While a significant portion of this energy is typically redirected back into the EV battery system through regenerative braking techniques, any surplus electrical energy that cannot be stored by the batteries must be diverted away from the motor and battery system to prevent damage to these components. A DBR may be utilized to convert the excess electrical energy into heat through the principle of resistance. As the resistor of the DBR heats up, the heat energy can be dissipated via a gas or liquid medium to avoid overheating of the DBR. Due to inherent size and space constraints EVs, as well as size and space constraints associated with other industrial and/or transportation applications, the size of the DBRs used to dissipate excess energy is necessarily limited. A critical parameter in evaluating the efficiency of such DBRs is brake resistor power density, which refers to the amount of power that the DBR can dissipate per unit volume or unit weight. Current DBR solutions have low break resistor power density and utilize haphazard liquid cooling, thereby creating resistor tube hot spots within the housing of the DBR. As such, a wider spacing between resistor tubes is required, thereby inhibiting heat transfer across resistor tube boundaries, decreasing heat flow for a given water flow rate, and increasing the overall weight and/or volume of the DBR.

Embodiments of the present invention provide a DBR with high-power density that does not unduly compromise on volume or weight constraints, providing benefits in applications in which size and space are premium considerations. To realize such improvements, a cyclonic flow, liquid cooled DBR with multiple nested coils is provided. The cyclonic flow, liquid cooled DBR utilizes nested helical resistor coils forming a spiral resistor structure. The spiral resistor structure of the cyclonic flow, liquid cooled DBR enables implementation of longer resistor tube lengths inside the DBR housing, thereby leading to improved structural support and a lower overall natural frequency of the resistor structure. Additionally, the spiral resistor structure provides improved fluid dynamics of the cooling liquid flowing through the DBR by formation of a cyclonic flow channel within the housing of the DBR. The improved flow path of the cooling liquid reduces or eliminates resistive tube hot spots (e.g., allowing for uniform cooling of the DBR), allows for closer spacing between individual resistor tube coils, improves heat transfer across resistor tube boundaries, and increases heat flow for the same cooling liquid flow rate as compared to conventional designs. Other benefits of the present invention are described herein below and will be readily apparent to those skilled in the art.

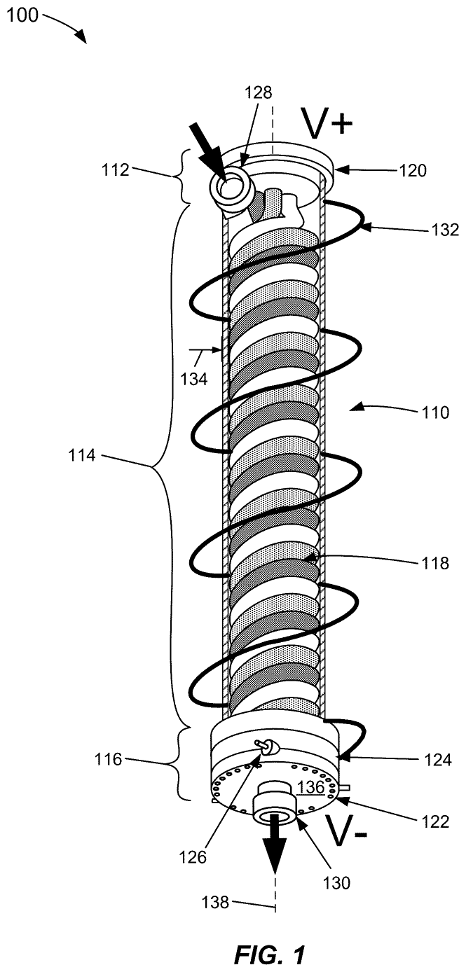

FIG. 1 illustrates an exemplary cyclonic flow, liquid cooled DBR 100 according to an embodiment of the present disclosure. Cyclonic flow, liquid cooled DBR 100 can include a housing 110 having a proximal end 112, a distal end 116, and an intermediate portion 114 therebetween. Housing 110 can be made of stainless-steel, aluminum, or other suitable material usable for forming a liquid tight and/or gas tight enclosure. In addition, housing 110 can be cylindrical in shape to surround and match an edge profile of a spiral resistor structure 118 positioned within housing 110. It will be appreciated that the opacity of housing 110 in intermediate portion 114 has been reduced in the drawing illustrating cyclonic flow, liquid cooled DBR 100 for illustrative purposes only and to enable viewing of spiral resistor structure 118 within housing 110.

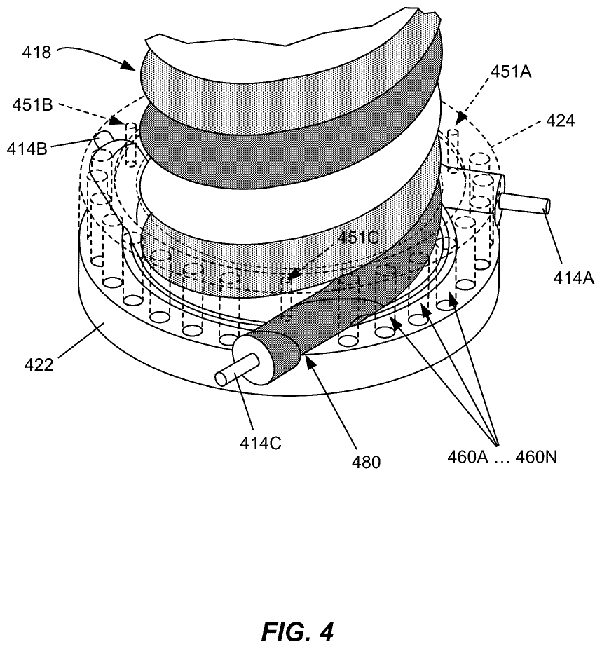

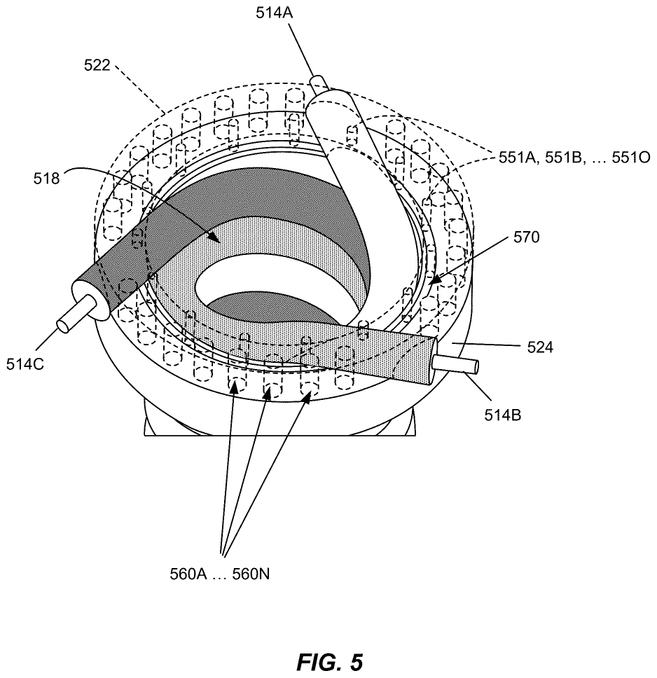

Intermediate portion 114 of housing 110 may be enclosed on either end to form a liquid tight and/or gas tight enclosure in order to seal the interior volume of housing 110. More specifically, proximal end 112 may be enclosed by a retention cover 120 and distal end 116 of housing 110 may be enclosed by a base cover 122. Enclosing proximal end 112 and distal end 116 of intermediate portion 114 enables the formation of a liquid and/or gaseous seal in the interior volume of housing 110. In some examples, such as the example shown in FIG. 1, distal end 116 may further include a support ring 124 that may slide down a length of intermediate portion 114 and couple to base cover 122 through a brazing technique, as described in more detail with respect to FIGS. 4 and 5. Inclusion of support ring 124 enables improved rigidity and support for output terminal 126 of the spiral resistor structure 118.

Housing 110 also includes an inlet port 128. In the example cyclonic flow, liquid cooled DBR 100 shown in FIG. 1, inlet port 128 is positioned on intermediate portion 114 near proximal end 112. Inlet port 128 is configured to receive a cooling liquid and/or gaseous cooling mixture to cool spiral resistor structure 118 positioned inside housing 110. Housing 110 also includes an outlet port 130. In the example cyclonic flow, liquid cooled DBR 100 shown in FIG. 1, outlet port 130 is positioned on a side 136 of base cover 122 opposing spiral resistor structure 118. Thus, in embodiments in which proximal end 112 is referred to as the top of cyclonic flow, liquid cooled DBR 100, side 136 may be referred as the bottom side of base cover 122 and cyclonic flow, liquid cooled DBR 100.

Outlet port 130 forms an opening in base cover 122, to allow (e.g., route) the cooling liquid and/or gaseous cooling mixture to flow out of the housing 110. Example cooling liquids can include water (e.g., deionized water, ethylene glycol-water mixtures, propylene glycol-water mixtures, etc.), oil (mineral oil, silicone oil, etc.), hydraulic fluids, fluorinated liquids, liquid-metal coolants, water-based coolants with additives, specialized coolants (e.g., perfluorocarbons or hydrofluoroethers) dielectric fluids, combinations of these cooling liquids, and the like. Example gaseous cooling mixtures can include air, nitrogen, gaseous refrigerants, combinations of these gaseous cooling mixtures, and the like. Control of the cooling liquid and/or gaseous cooling mixture flowing into inlet port 128 and out of outlet port 130 may be controlled by any suitable valve type mechanism/structure. One of ordinary skill in the art would recognize many variations, modifications, and alternatives.

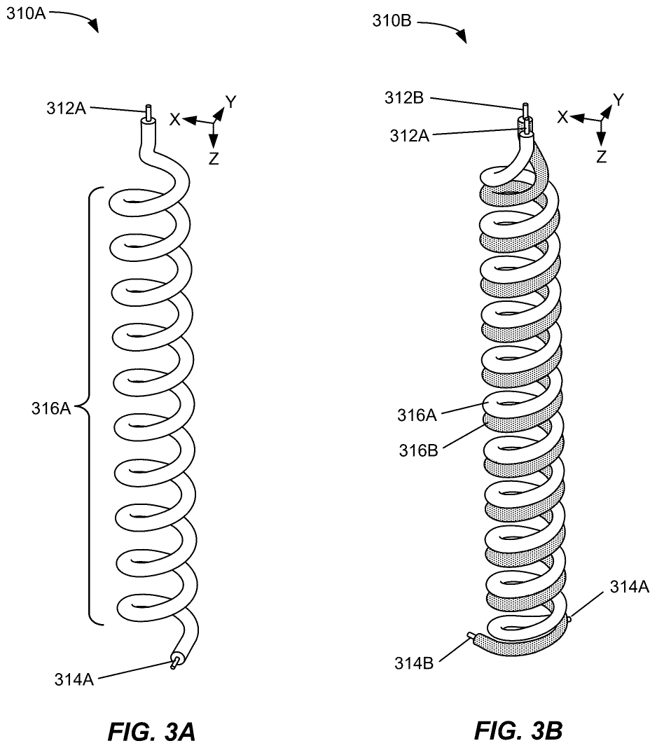

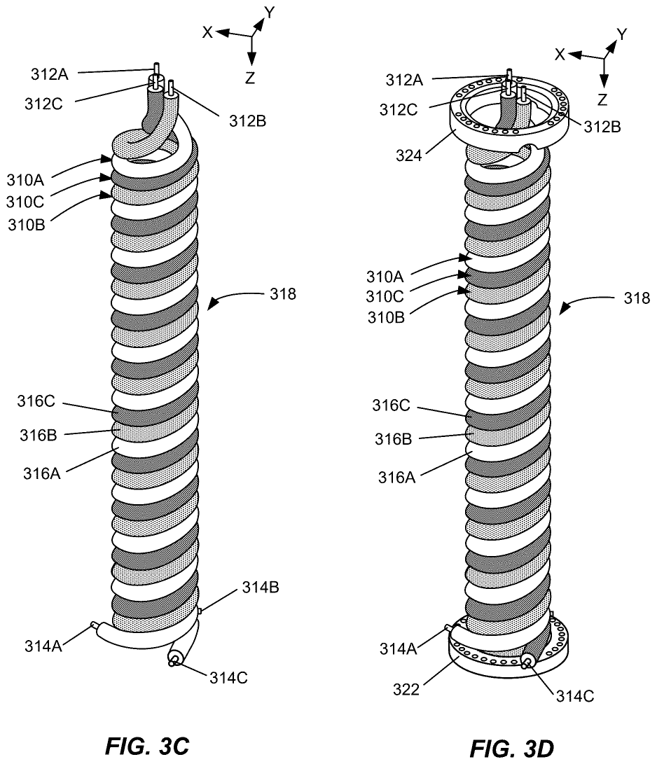

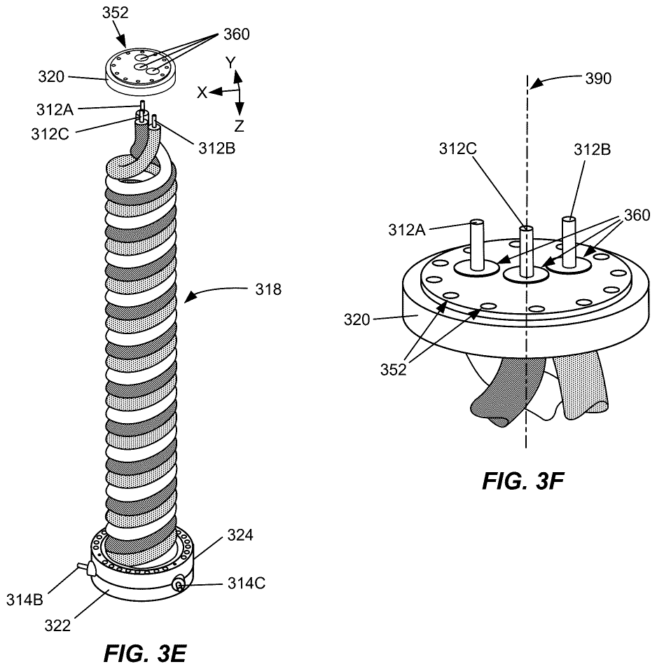

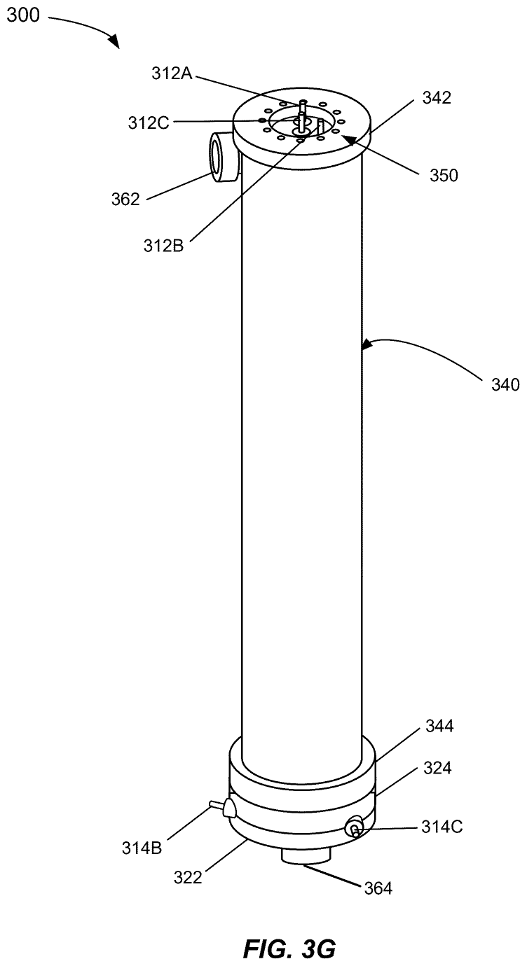

As previously mentioned, spiral resistor structure 118 is positioned within housing 110 of cyclonic flow, liquid cooled DBR 100. Spiral resistor structure 118 is described in more detail below with respect to FIGS. 3A-5, however, in general, spiral resistor structure 118 can include one or more resistor tubes, where each resistor tube forms a helical shaped resistor coil. Each helical shaped resistor coil of the spiral resistor structure 118 can be nested within each other helical shaped resistor coil (e.g., screwed together, set into, or interwoven together) to form the spiral resistor structure. In cyclonic flow, liquid cooled DBR 100 of FIG. 1, three helical shaped resistor coils are nested together to form the spiral resistor structure 118. Although not explicitly shown in FIG. 1, but as described in more detail below with respect to FIGS. 3A-5, each helical shaped resistor coil includes an input electrical terminal and an output electrical terminal. In the example cyclonic flow, liquid cooled DBR 100 of FIG. 1, the input electrical terminals protrude out of the retention cover 120 (not shown) and the output electrical terminals are positioned and protrude out of the base cover 122 as illustrated by output terminal 126.

In operation, the input electrical terminals and the output electrical terminals of spiral resistor structure 118 may be coupled, for example, to an electric motor in an industrial or transportation application. When the electric motor is running, the electric motor may generate excess electrical energy. To prevent damage to the electric motor, the excess electrical energy (i.e., electrical current) can flow through the input electrical terminals to the output electrical terminals of cyclonic flow, liquid cooled DBR 100. As the current flows through the helical shaped resistor coils, spiral resistor structure 118 dissipates the electrical energy in the form of heat through the principle of resistance. As spiral resistor structure 118 heats up, the heat energy in the helical shaped resistor coils can be dissipated via a cooling liquid and/or gaseous cooling mixtures flowing through housing 110 (e.g., in through inlet port 128 and out of outlet port 130) to avoid overheating spiral resistor structure 118. Dissipation of the excess electrical energy in the form of heat ensures system stability, safety, and overall longevity of components.

FIG. 1 further illustrates a flow path 132 of a cooling liquid and/or gaseous cooling mixtures used with cyclonic flow, liquid cooled DBR 100. As previously mentioned, when electrical current flows through spiral resistor structure 118 for purposes of heat dissipation, the helical shaped resistor coils will heat up. To prevent damage to the cyclonic flow, liquid cooled DBR 100 and spiral resistor structure 118, a cooling liquid and/or gaseous cooling mixture can flow in through inlet port 128 and be expelled out of outlet port 130. As the cooling liquid and/or gaseous cooling mixture flows over the helical shaped resistor coils, heat transfers from the helical shaped resistor coils to the cooling liquid and/or gaseous cooling mixture. As a result, a temperature of the cooling liquid and/or gaseous cooling mixture is increased, thereby leading to a decrease in temperature of spiral resistor structure 118. The increased temperature cooling liquid and/or gaseous cooling mixture is then expelled (i.e., routed) out of outlet port 130 and, in some examples, is recirculated through the system and reintroduced, at a lower temperature after interaction with a heat exchanger, for example, injected back through inlet port 128. As shown in FIG. 1, the cooling liquid and/or gaseous cooling mixture is tangentially received by inlet port 128 and axially routed out of the housing 110 by outlet port 130. Positioning the outlet port 130 on side 136 of base cover 122 enables the cooling liquid and/or gaseous cooling mixture to contact and flow over the entire length of the spiral resistor structure further reducing hot spots.

The nested, helical shaped resistor coils of spiral resistor structure 118 in combination with the cylindrical shape of intermediate portion 114 enables improved fluid dynamics as the cooling liquid and/or gaseous cooling mixture flows through housing 110. In other words, the various components enable a cyclonic flow of cooling liquid and/or gaseous cooling mixture around an outer surface of spiral resistor structure 118, as shown by flow path 132. The cyclonic flow of the cooling liquid and/or gaseous cooling mixture enables the formation of a cyclonic flow channel 134 defined in a space between an outer portion of spiral resistor structure 118 and an inner sidewall portion of intermediate portion 114 of housing 110. Formation of cyclonic flow channel 134 improves flow path 132 of the cooling liquid and/or gaseous cooling mixture, thereby reducing or eliminating hot spots formed on the helical shaped resistor coils. In some embodiments, the cyclonic flow and the cyclonic flow channel 134 enables the cooling liquid and/or gaseous cooling mixture to exhibit laminar flow through the housing 110. In these embodiments, laminar flow may refer to a flow where the fluid or gaseous particles move in smooth, parallel layers with minimal mixing (as opposed to turbulent flow).

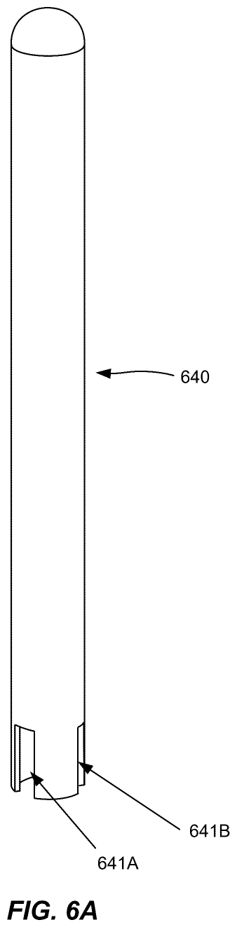

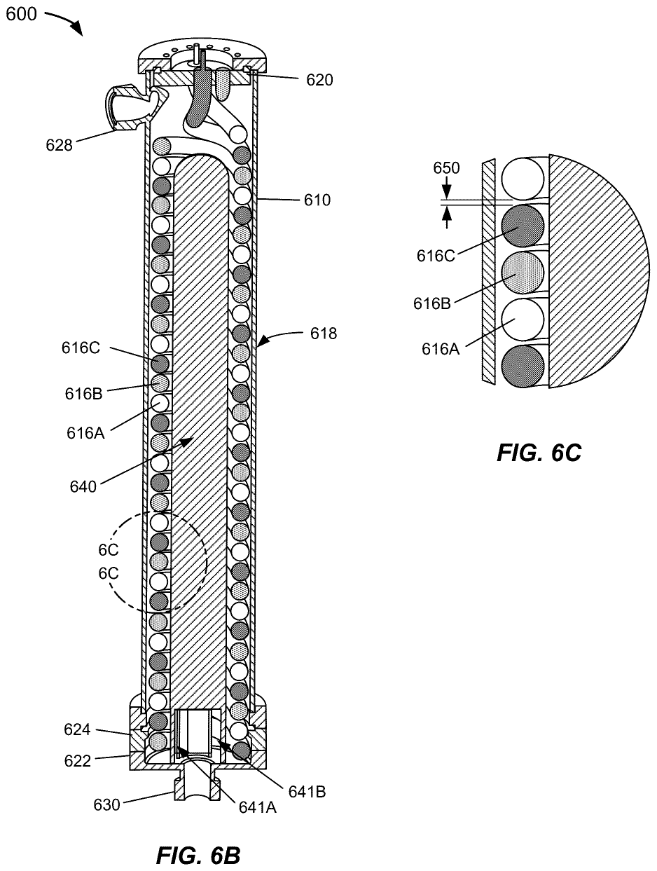

In addition to improved cooling, via the cyclonic flow channel 134, in the space between the outer portion of spiral resistor structure 118 and the inner sidewall portion of intermediate portion 114 of housing 110, embodiments of the present disclosure also improve cooling on an inner portion of spiral resistor structure 118. That is, the various components enable cyclonic flow within an inner space of spiral resistor structure 118 so that the cooling liquid and/or gaseous cooling mixture also contacts an inner portion of spiral resistor structure 118 (e.g., a side of the spiral resistor coils facing a central axis 138, 390 of the housing 110). In more detail, a hollow region (e.g., a cavity) may be formed within the spiral resistor structure 118 by virtue of the helical shape of the individual resistor coils. Thus, in addition to the cyclonic flow channel 134 formed in the space between the outer portion of spiral resistor structure 118 and the inner sidewall portion of intermediate portion 114 of housing 110 (e.g., a first cyclonic flow channel, a primary cyclonic flow channel), another cyclonic flow channel can be formed within the cavity formed inside (e.g., in a radial direction toward the central axis 138, 390) the inner sidewall portion of housing 110 around central axis 138, 390 (e.g., a second cyclonic flow channel, a secondary cyclonic flow channel). In some examples, the first and second cyclonic flow channels may substantially flow in a circular nature with respect to the central axis 138, 390. Furthermore, and as described in more detail with respect to FIGS. 6A-6C, a flow diverter can be used in some embodiments to further bring the cooling liquid and/or gaseous cooling mixture flowing on the interior side of the resistor coils into more intimate contact with the resistor coils to improve heat transfer and eliminate hot spots on the inward facing sides of the resistor coils.

In addition, the improved cooling of spiral resistor structure 118 allows for closer spacing between the respective helical shaped resistor tube coils. In turn, this closer spacing allows for a longer length of resistor tube coil to be utilized for the same volume of space, which has the benefit of not only increasing the heat transfer area of the resistor tube coil, but also increasing the overall natural frequency of spiral resistor structure 118 by enhancing its structural rigidity and reducing the likelihood of resonance with external vibrations. In addition, cyclonic flow channel 134 improves heat transfer across helical shaped resistor coils boundaries to the cooling liquid and/or gaseous cooling mixture as well as provides for an increase in heat flow for the same cooling flow rate as compared to conventional designs.

In some embodiments, such as the cyclonic flow, liquid cooled DBR 100 of FIG. 1, the individual resistor tube coils of the spiral resistor structure 118 are separated by a gap (i.e., not physically touching), for example, an air gap when the cyclonic flow, liquid cooled DBR 100 is not filled with a fluid, characterized by a uniform spacing. The gap between individual resistor tube coils of the spiral resistor structure 118 is illustrated in more detail with reference to gap 650 illustrated in FIGS. 6B and 6C. Use of a uniform spacing between the resistor tube coils further improves the cooling capabilities of cyclonic flow, liquid cooled DBR 100 by increasing the effective surface area of the spiral resistor structure 118. The increased effective surface area enables the cooling liquid and/or gaseous cooling mixture to contact more surface area of (e.g., flow over) the individual resistor tube coils and, thereby, more effectively transfer heat from the resistor tube coils to the cooling liquid and/or gaseous cooling mixture.

Cyclonic flow, liquid cooled DBR 100 of FIG. 1 is different than conventional designs, which, as described above, typically rely on a single-sided configuration in which input and output electrical terminals are accessible from the same side of the DBR housing, and the resistors tubes are typically U-shaped. In such conventional designs, electrical terminals of the resistor tubes are all oriented in a same direction (e.g., protruding outwards from the same end of the DBR housing), and as a result, the resistor coils cannot be nested together, are shorter in length, and have limited power dissipation ratings due to poor cooling functionality.

In contrast, cyclonic flow, liquid cooled DBR 100 of FIG. 1 is defined by a double-sided configuration, where electrical terminals of the resistor structure are accessible (e.g., protrude outwards) at opposing ends of the housing 110. Moreover, as illustrated in FIG. 1, electrical terminals at the proximal end 112 have a different orientation as compared to the electrical terminals at the distal end 116. That is, electrical terminals at the proximal end 112 are axially oriented (e.g., vertically aligned and parallel to a central axis running longitudinally down the center of spiral resistor structure 118) and electrical terminals at the distal end 116 are tangentially orientated around the circumference of base cover 122. As described in more detail with respect to FIGS. 3A-3G, the axial and circumferential orientation of the electrical terminals in conjunction with lateral and circumferential offsets enables multiple helical resistor coils to be nested (e.g., screwed, set into, or interwoven) together to form the spiral resistor structure 118.

The double-sided configuration of the cyclonic flow, liquid cooled DBR 100 improves the power dissipation rating due to an increase in resistor tube area by virtue of the spiral resistor structure as well as a reduction and lower ranges of hot spot temperatures on the resistor tube coils due to improved cooling by virtue of improved fluid dynamics.

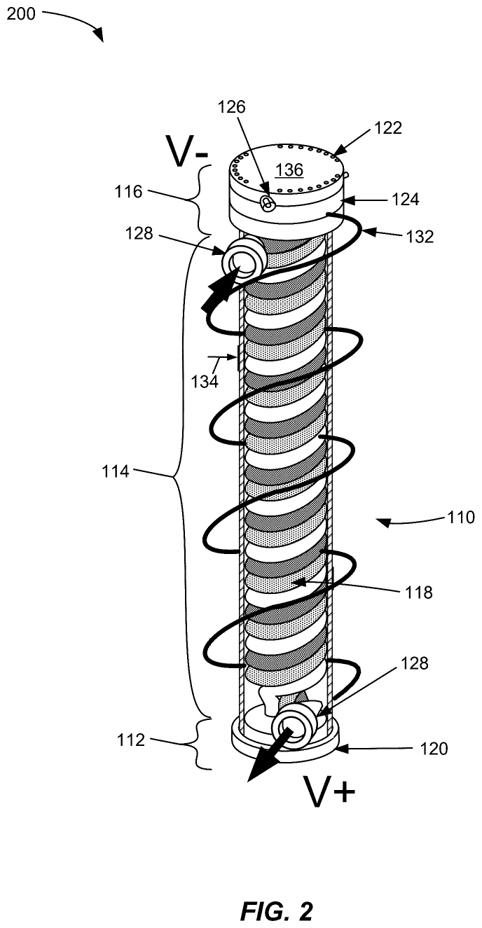

FIG. 2 illustrates another exemplary cyclonic flow, liquid cooled DBR 200 according to an embodiment of the present disclosure. Cyclonic flow, liquid cooled DBR 200 includes many of the same features described above in relation to cyclonic flow, liquid cooled DBR 100 illustrated in FIG. 1. The similar elements in cyclonic flow, liquid cooled DBR 200 therefore may share description as the corresponding element described above in relation to cyclonic flow, liquid cooled DBR 100, and as a result, the description references prior discussion of similar functionality.

As shown in FIG. 2, cyclonic flow, liquid cooled DBR 200 includes housing 110 having proximal end 112, distal end 116, and intermediate portion 114 therebetween. Similar to cyclonic flow, liquid cooled DBR 100, housing 110 can be cylindrical in shape to surround and match an edge profile of spiral resistor structure 118 positioned within the housing 110, where spiral resistor structure 118 is configured to dissipate electrical energy received, for example, from an electric motor. Cyclonic flow, liquid cooled DBR 200 also includes inlet port 128 and outlet port 130 for receiving and expelling, respectively, the cooling liquid and/or gaseous cooling mixture to transfer heat from the individual helical shaped resistor coils of spiral resistor structure 118 to the cooling liquid and/or gaseous cooling mixture in order to prevent overheating. In contrast with cyclonic flow, liquid cooled DBR 100, inlet port 128 and outlet port 130 are positioned in different regions of housing 110 in cyclonic flow, liquid cooled DBR 200.

More specifically, inlet port 128 is positioned on intermediate portion 114 near distal end 116 and outlet port 130 is positioned on intermediate portion 114 near proximal end 112. In the embodiment shown in FIG. 2, inlet port 128 can tangentially receive the cooling liquid and/or gaseous cooling mixture and outlet port 130 can tangentially route the cooling liquid and/or gaseous cooling mixture out of the housing 110 after the heat transfer process. In some embodiments, inlet port 128 can be positioned on side 136 of base cover 122 to axially receive the cooling liquid and/or gaseous cooling mixture and outlet port 130 can be positioned on intermediate portion 114 near proximal end 112 to tangentially route the cooling liquid and/or gaseous cooling mixture out of the housing 110 after the heat transfer process.

Importantly, positioning both inlet port 128 and outlet port 130 on intermediate portion 114 or in another configuration (e.g., inlet port 128 on side 136 of base cover 122) is not a mere rearrangement of elements. As previously mentioned, due to inherent size and space constraints of vehicles and/or other systems employing electric motors, the size of a corresponding brake resistor implemented in such systems is necessarily limited. As such, the embodiment illustrated by FIG. 2 provides added flexibility and reduced size (e.g., by virtue of the overall reduction in length) of cyclonic flow, liquid cooled DBR 200 without compromising on other features, such as without reducing the overall interior volume of the housing, without reducing the overall length of the helical shaped resistor tubes, etc. As such, the embodiment illustrated by FIG. 2 provides a more compact design for a cyclonic flow, liquid cooled DBR that may be suitable for certain applications where space, coolant line positioning, etc. are of premium consideration.

FIG. 3A illustrates a perspective view of a first helical resistor coil 310A according to an embodiment of the present disclosure. First helical resistor coil 310A can include a first input electrical terminal 312A, a first output electrical terminal 314A, and a plurality of first coils 316A connecting first input electrical terminal 312A to first output electrical terminal 314A. First helical resistor coil 310A can have a length and comprise a tube structure formed from multiple elements. For instance, first helical resistor coil 310A can include an inner conductor, such as a Nickel-chromium (NiCr) alloy, extending the length of first helical resistor coil 310A and having an inner conductor diameter. In some examples, the inner conductor diameter may be between 3 mm and 5 mm, and in one particular example, such as the example shown in FIG. 3A, the inner conductor diameter is about 4.2 mm. In some examples, the length of the inner conductor, corresponding to the length of first helical resistor coil 310A, may be between 2,000 mm and 2,400 mm, and in one particular example, such as the example shown in FIG. 3A, the length of the inner conductor is about 2,200 mm. The inner conductor can conduct electricity (i.e., current) received from one of the electrical terminals (i.e., first input electrical terminal 312A or first output electrical terminal 314A) and convert the electrical current into heat through the principle of resistance.

The inner conductor can be surrounded by an insulator, such as Magnesium Oxide (MgO). The insulator surrounding the inner conductor prevents electrical conduction between the inner conductor and other components of the resistor structure (e.g., the outer casing, the housing, etc.) ensuring the inner conductor operates safely and within its designed electrical characteristics. The insulator may be enclosed by a tubing material having an outer diameter. In some examples, the outer diameter of the tubing material may be between 12 mm and 16 mm, and in one particular example, such as the example shown in FIG. 3A, the outer diameter of the tubing material is about 14 mm. The power capacity for first helical resistor coil 310A is defined by the length of the inner conductor and the inner conductor diameter for a given inner resistive element material.

In addition, the plurality of first coils 316A connecting first input electrical terminal 312A to first output electrical terminal 314A can be defined by a bend radius. In some examples, the bend radius may be between 1.5 inches to 2 inches, and in one particular example, such as the example shown in FIG. 3A, the bend radius of each coil of the plurality of first coils 316A is about 1.7 inches. As mentioned previously, the inner conductor of each helical resistor coil is filled with an insulator, such as a MgO powder. In conventional, single-sided, U-shaped DBR configurations, the U-shaped bend may be between 1 inch to 1.5 inches and in a particular conventional design, the U-shaped bend radius is about 1.3 inches. As such, the bend radius according to embodiments of the present invention is larger (e.g., less severe) than those of conventional designs. It will be appreciated that a more severe bend radius (e.g., a smaller bend radius value) leads to a higher risk that the internal conductor of the resistor tube moves or is damaged. As such, embodiments of the present invention provide for improved structural rigidity by providing a larger and less severe bend radius of the resistor coils, thereby reducing a potential for damage to the internal conductor.

As further illustrated by FIG. 3A, first input electrical terminal 312A and first output electrical terminal 314A have differing orientations. In more detail, first input electrical terminal 312A is vertically aligned and/or parallel to a central axis running longitudinally down the center of first helical resistor coil 310A, and first output electrical terminal 314A is oriented circumferentially around the central axis. The lateral and circumferential positioning of the electrical terminals is described in more detail below with respect to FIGS. 3B-3F.

FIG. 3B illustrates a perspective view of a second helical resistor coil 310B nested within the first helical resistor coil 310A of FIG. 3A according to an embodiment of the present disclosure. Second helical resistor coil 310B can include a second input electrical terminal 312B, a second output electrical terminal 314B, and a plurality of second coils 316B connecting second input electrical terminal 312B to second output electrical terminal 314B. Second helical resistor coil 310B can have a similar length and a similar tube structure as described with respect to first helical resistor coil 310A. For instance, second helical resistor coil 310B can include an inner conductor, such as a NiCr alloy, extending for the length of the second helical resistor coil 310B and having an inner conductor diameter. In some examples, the inner conductor diameter may be between 3 mm and 5 mm, and in one particular example, such as the example shown in FIG. 3B, the inner conductor diameter is about 4.2 mm. In some examples, the length of the inner conductor, corresponding to the length of the second helical resistor coil 310B, may be between 2,000 mm and 2,400 mm, and in one particular example, such as the example shown in FIG. 3B, the length of the inner conductor is about 2,200 mm. The inner conductor can conduct electricity (i.e., current) received from one of the electrical terminals (e.g., second input electrical terminal 312B or second output electrical terminal 314B) and convert the electrical current into heat through the principle of resistance.

Similar to first helical resistor coil 310A, the inner conductor can be surrounded by an insulator, such as MgO. The insulator surrounding the inner conductor prevents electrical conduction between the inner conductor and other components of the resistor structure (e.g., the outer casing, the housing, etc.) ensuring the inner conductor operates safely and within its designed electrical characteristics. The insulator may be enclosed by a tubing material having an outer diameter. In some examples, the outer diameter of the tubing material may be between 12 mm and 16 mm, and in one particular example, such as the example shown in FIG. 3B, the outer diameter of the tubing material is about 14 mm. The power capacity for second helical resistor coil 310B is defined by the length of the inner conductor and the inner conductor diameter for a given inner resistive element material. In addition, the plurality of second coils 316B connecting second input electrical terminal 312B to second output electrical terminal 314B can be defined by a bend radius. In some examples, the bend radius may be between 1.5 inches to 2 inches, and in one particular example, such as the example shown in FIG. 3B, the bend radius of each coil of the plurality of second coils 316B is about 1.7 inches. As mentioned with respect to FIG. 3A, embodiments of the present invention utilize a larger, less severe bend radius of the resistor coils, thereby reducing the potential of damaging the internal conductor.

As further illustrated by FIG. 3B, first helical resistor coil 310A is nested (e.g., screwed or interwoven) within second helical resistor coil 310B to form a spiral resistor structure.

Additionally, and although not illustrated in FIG. 3B, the plurality of first coils 316A and the plurality of second coils 316B are not physically touching and can be separated by a uniform spacing. Moreover, second input electrical terminal 312B has an orientation that matches the orientation of first input electrical terminal 312A (alignment with the central axis running along the length of the spiral resistor structure); however, as shown in FIG. 3B, second input electrical terminal 312B is laterally offset from first input electrical terminal 312A. Second output electrical terminal 314B is oriented circumferentially around the central axis running along the length of the spiral resistor structure, similar to first output electrical terminal 314A, but circumferentially offset. In the embodiment shown in FIG. 3B, second output electrical terminal 314B and first output electrical terminal 314A are circumferentially offset by 180°. In other embodiments and depending on the particular application, different circumferential offsets may be used such as circumferential offsets of 120°, 60°, and so on.

The lateral and circumferential offsets of the input/output terminals enables first helical resistor coil 310A and second helical resistor coil 310B to be nested/screwed together. For instance, without lateral and circumferential offsets of the input/output terminals, the input terminals of respective helical resistor coils would abut each other and cause an undesirable force against each other and could lead to a damaging of the components.

FIG. 3C illustrates a perspective view of a third helical resistor coil 310C nested within the first helical resistor coil 310A and the second helical resistor coil 310B of FIG. 3B according to an embodiment of the present disclosure. Third helical resistor coil 310C can include a third input electrical terminal 312C, a third output electrical terminal 314C, and a plurality of third coils 316C connecting third input electrical terminal 312C to third output electrical terminal 314C. Third helical resistor coil 310C can have a similar length and a similar tube structure as described with respect to first helical resistor coil 310A and second helical resistor coil 310B. For instance, third helical resistor coil 310C can include an inner conductor, such as a NiCr alloy, extending for the length of the third helical resistor coil 310C and having an inner conductor diameter. In some examples, the inner conductor diameter may be between 3 mm and 5 mm, and in one particular example, such as the example shown in FIG. 3C, the inner conductor diameter is about 4.2 mm. In some examples, the length of the inner conductor, corresponding to the length of the third helical resistor coil 310C, may be between 2,000 mm and 2,400 mm, and in one particular example, such as the example shown in FIG. 3C, the length of the inner conductor is about 2,200 mm. The inner conductor can conduct electricity (i.e., current) received from one of the electrical terminals (i.e., third input electrical terminal 312C or third output electrical terminal 314C) and convert the electrical current into heat through the principle of resistance.

Similar to above with respect to first helical resistor coil 310A and second helical resistor coil 310B, the inner conductor can be surrounded by an insulator, such as MgO. The insulator surrounding the inner conductor prevents electrical conduction between the inner conductor and other components of the resistor structure (e.g., the outer casing, the housing, etc.) ensuring the inner conductor operates safely and within its designed electrical characteristics.

The insulator may be enclosed by a tubing material having an outer diameter. In some examples, the outer diameter of the tubing material may be between 12 mm and 16 mm, and in one particular example, such as the example shown in FIG. 3C, the outer diameter of the tubing material is about 14 mm. The power capacity for third helical resistor coil 310C is defined by the length of the inner conductor and the inner conductor diameter for a given inner resistive element material. In addition, the plurality of third coils 316C connecting third input electrical terminal 312C to third output electrical terminal 314C can be defined by a bend radius. In some examples, the bend radius may be between 1.5 inches to 2 inches, and in one particular example, such as the example shown in FIG. 3C, the bend radius of each coil of the plurality of third coils 316C is about 1.7 inches. As mentioned with respect to FIGS. 3A and 3B, embodiments of the present invention utilize a larger, less severe bend radius of the resistor coils, thereby reducing a potential of damaging the internal conductor.

As further illustrated by FIG. 3C, first helical resistor coil 310A and second helical resistor coil 310B are nested (e.g., screwed) within third helical resistor coil 310C to form a spiral resistor structure 318. Additionally, and although not illustrated in FIG. 3C, the plurality of first coils 316A, the plurality of second coils 316B, and the plurality of third coils 316C are not physically touching and are separated by a uniform spacing. Third input electrical terminal 312C has an orientation that matches first input electrical terminal 312A and second input electrical terminal 312B (alignment with the central axis running along the length of the spiral resistor structure 318); however, as shown in FIG. 3C, third input electrical terminal 312C is laterally offset from both first input electrical terminal 312A and second input electrical terminal 312B. Third output electrical terminal 314C is oriented circumferentially around the central axis running along the length of the spiral resistor structure, similar to first output electrical terminal 314A and second output electrical terminal 314B; however, as shown in FIG. 3C, first output electrical terminal 314A, second output electrical terminal 314B, and third output electrical terminal 314C are circumferentially offset by 120°.

FIG. 3D illustrates a perspective view of the spiral resistor structure 318 of FIG. 3C coupled to a base cover 322 and having a support ring 324 according to an embodiment of the present disclosure. Base cover 322 and support ring 324 each include many of the same features described above in relation to the base cover 122 and support ring 124 illustrated in FIG. 1. The similar elements therefore may share description as the corresponding element described above with respect to FIG. 1, and as a result, the description references prior discussion of similar functionality. As described with respect to FIG. 1, base cover 322 can form a support for a bottom portion of spiral resistor structure 318. Additionally, a plurality of notches may be formed in the base cover 122 corresponding to the output electrical terminals (i.e., first output electrical terminal 314A, second output electrical terminal 314B, and third output electrical terminal 314C). The output electrical terminals may protrude out of the notches to be electrically connected to other components in an electrical system. Support ring 324 may slide over spiral resistor structure 318 and couple, via a brazing technique described in more detail with respect to FIGS. 4 and 5, with base cover 322. Inclusion of support ring 324 enables improved rigidity and support for the output electrical terminals of spiral resistor structure 318.

FIG. 3E illustrates a perspective view of spiral resistor structure 318 of FIG. 3D with a retention cover 320 according to an embodiment of the present disclosure. Retention cover 320 includes many of the same features described above in relation to the retention cover 120 illustrated in FIG. 1. The similar elements therefore may share description as the corresponding element described above with respect to FIG. 1, and as a result, the description references prior discussion of similar functionality. Retention cover 320 includes a plurality of openings 360 configured to receive electrical terminals, such as first input electrical terminal 312A, second input electrical terminal 312B, and third input electrical terminal 312C. The input terminals protrude out of the openings 360 to be electrically connected to other components in an electrical system. The retention cover 320 provides structural support to the electrical terminals as well as enclosing the housing. Retention cover 320 also includes a plurality of brazing holes 352. Brazing holes 352 may receive a brazing material, such as a molten metal filler, as described in more detail below with respect to FIGS. 4 and 5.

FIG. 3F is a perspective view of retention cover 320 and electrical terminals according to an embodiment of the present disclosure. Retention cover 320 may slide over first input electrical terminal 312A, second input electrical terminal 312B, and third input electrical terminal 312C of the spiral resistor structure 318 such that the electrical terminals axially protrude outwards through openings 360. In this way, retention cover 320 provides structural support to the electrical terminals as well as an enclosure for the housing. As illustrated in FIG. 3F, each of the electrical terminals and the corresponding openings 360 are laterally offset. That is, third input electrical terminal 312C is axially aligned with a central axis 390 running longitudinally down the center of spiral resistor structure 318, and each of first input electrical terminal 312A and second input electrical terminal 312B are laterally offset from the central axis 390. Without the lateral offsets as shown in FIG. 3F, respective helical resistor coils could not be nested together because the ends of the electrical terminals would be positioned at the same lateral position and prevent nesting.

FIG. 3G illustrates a perspective view of the spiral resistor structure 318 of FIG. 3E with a housing 340 according to an embodiment of the present disclosure. Housing 340 includes many of the same features described above in relation to the housing 110 illustrated in FIG. 1. The similar elements therefore may share description as the corresponding element described above with respect to FIG. 1, and as a result, the description references prior discussion of similar functionality. As illustrated by FIG. 3G, housing 340 may slide over retention cover 320 and over the spiral resistor structure 318. Housing 340 includes a first end 342 and a second end 344. First end 342 includes a plurality of brazing holes 350 which can receive a brazing material, such as a molten metal filler, as described in more detail below with respect to FIGS. 4 and 5, to form a joint between the first end 342 and the retention cover 320. Coupling the housing 340 to respective ends of the spiral resistor structure 318 encloses the spiral resistor structure 318 in a liquid and/or gas tight sealed container. As described with respect to FIG. 1, housing 340 may comprise stainless-steel, aluminum, or other suitable material usable for forming a liquid tight and/or gas tight enclosure.

FIG. 3G also shows an inlet port 362 and an outlet port 364. Similar to inlet port 128 described above with respect to FIG. 1, inlet port 362 is positioned on housing 340 in a location near the first end 342 and retention cover 320. Inlet port 362 is configured to receive a cooling liquid and/or gaseous cooling mixture to cool spiral resistor structure 318 positioned inside housing 340. Similarly, outlet port 364 is defined on a bottom side of base cover 322. Outlet port 364 forms an opening in base cover 322, to allow the cooling liquid and/or gaseous cooling mixture to flow out of the housing 340 to be discarded and/or re-circulated. As described with respect to FIG. 1, example cooling liquids can include water (e.g., deionized water, ethylene glycol-water mixtures, propylene glycol-water mixtures, etc.), oil (mineral oil, silicone oil, etc.), hydraulic fluids, fluorinated liquids, liquid-metal coolants, water-based coolants with additives, specialized coolants (e.g., perfluorocarbons or hydrofluoroethers) dielectric fluids, and so on, and example gaseous cooling mixtures can include air, nitrogen, gaseous refrigerants, and so on. Control of the cooling liquid and/or gaseous cooling mixture through the inlet port 128 and out of the outlet port 130 may be control by any suitable valve type structure.

FIG. 4 illustrates a first perspective view of a base cover 422 and support ring 424 for a spiral resistor structure 418 according to an embodiment of the present disclosure. As shown in FIG. 4, base cover 422 can include a plurality of notches 480 oriented circumferential around the circumference of base cover 422 and configured to receive electrical terminals of spiral resistor structure 418. In the example shown in FIG. 4, first output electrical terminal 414A, second output electrical terminal 414B, and third output electrical terminal 414C are illustrated and positioned around the circumference of base cover 422 circumferentially offset by 120°. Although three output electrical terminals are shown, it will be appreciated that in some example spiral resistor structures less output electrical terminals is possible, such as spiral resistor structures having one or two helical resistor elements. Additionally, while the electrical terminals are described being “output” electrical terminals, in some examples, such terminals may be “input” electrical terminals such as the case where first output electrical terminal 414A, second output electrical terminal 414B, and third output electrical terminal 414C of the spiral resistor structure 418 are connected to a positive voltage source.

As shown in FIG. 4, support ring 424 comprises a plurality of riser holes. More specifically, first riser hole 451A is positioned above first output electrical terminal 414A, second riser hole 451B is positioned above second output electrical terminal 414B, and third riser hole 451C is positioned above third output electrical terminal 414C. Support ring 424 also comprises a plurality of brazing holes 460A, 460B, . . . 460N vertically extending through support ring 424 and extending into base cover 422 (extension portions into base cover 422 not shown). Inclusion of the plurality of riser holes and plurality of brazing holes in the support ring 424 and the plurality of brazing holes in the base cover 422 enables the support ring 424 and the base cover 422 to be joined together. In some examples, a a brazing technique can be used to join the base cover 422 and the support ring 424. For instance, during a brazing metal-joining process, each of the support ring 424 and base cover 422 may be heated to a suitable temperature. Each of the plurality of brazing holes and the plurality of riser holes are then filled using a molten filler material (e.g., a molten metal, a non-metallic material, or other suitable composition) having a lower melting point than the materials forming the support ring 424 and base cover 422. The molten filler material then is drawn into the plurality of brazing holes and the plurality of riser holes via capillary action. As the molten filler material cools and solidifies a joint between the support ring 424 and base cover 422 is formed thereby sealing the two components together. In addition, and through the use of the plurality of riser holes, the molten filler material can adhere to the tubing material of the helical resistor coils of spiral resistor structure 418 to secure the helical shaped resistor coils in place. Similar joining techniques may be utilized to join the retention cover portion of the spiral resistor structure. For instance, as described with respect to FIGS. 3E and 3F, first end 342 of housing 340 and retention cover 320 each comprise a plurality of brazing holes 350, 352, respectively. Such brazing holes may receive a similar molten filler material that is drawn into the plurality of brazing holes via capillary action to form a sealed joint between the retention cover 320 and the housing 340.

FIG. 5 illustrates a second perspective view of a base cover 522 and support ring 524 for a spiral resistor structure 518 according to an embodiment of the present disclosure. It will be appreciated that in some examples, more or less brazing holes and/or more or less riser holes as compared to FIG. 4 is possible, depending on the desired strength of the joint and the particular application. For instance, certain applications employing a dynamic brake resistor, such as various aerospace, naval, automatic, industrial applications, and the like, may require a stronger joint between the components due to the increased stresses involved. In the example shown in FIG. 5, base cover 522 includes fifteen riser holes 551A . . . 551O disposed circumferentially around the base cover 522 and above first output electrical terminal 514A, second output electrical terminal 514B, and third output electrical terminal 514C. In addition, base cover 522 includes a circular channel 570 connecting riser holes 551A . . . 551O. Similar to FIG. 4, base cover 522 also includes a plurality of brazing holes 560A . . . 560N vertically extending through base cover 522 and into support ring 524. During a brazing process, a molten filler material (e.g., a molten metal, a non-metallic material, or other suitable composition) may be introduced to base cover 522 and be drawn into the plurality of brazing holes 560A . . . 560N and by the riser holes 551A . . . 551O via capillary action to form a sealed joint due when the molten filler material cools and solidifies. Thus, the structures, including the channel and risers shown in FIG. 5 enable distribution of molten metal or non-metallic material to join and seal the components illustrated in FIG. 5. As will be evident to one of skill in the art, these molten metals or other fluid materials may be of different compositions and temperatures compared to typical brazing temperatures and materials.

FIG. 6A is a perspective view of a flow diverter 640 according to an embodiment of the present disclosure. Flow diverter 640 may be inserted into a spiral resistor structure to improve the fluid dynamics of the cooling liquid and/or gaseous cooling mixture used to cool the spiral resistor structures. In some embodiments, such as the embodiment shown in FIG. 6A, flow diverter 640 is smooth. In other embodiments, flow diverter 640 may include a plurality of ribs formed on the outer surface of the flow diverter 640. The plurality of ribs may have a helical shape that corresponds to the helical shape of the resistor coils. Inclusion of the ribs can improve the flow of the cooling liquid and/or gaseous cooling mixture to more effective transfer heat from the spiral resistor coil to the cooling liquid and/or gaseous cooling mixture. In some embodiments, flow diverter 640 can be hollow to reduce weight. Additionally, flow diverter 640 includes slots 641A, 641B formed in a base portion of flow diverter 640 to enable the cooling liquid and/or gaseous cooling mixture to be routed out of the DBR housing, as described in more detail with respect to FIG. 6B.

FIG. 6B illustrates a cross-sectional view of an exemplary cyclonic flow, liquid cooled DBR 600 including a flow diverter 640 according to an embodiment of the present disclosure. Cyclonic flow, liquid cooled DBR 600 includes many of the same features described above in relation to the cyclonic flow, liquid cooled DBR 100 and the various components described with respect to FIGS. 3A-3F. Accordingly, the description provided in relation to cyclonic flow, liquid cooled DBR 100 illustrated in FIGS. 1 and 3A-3F are applicable to cyclonic flow, liquid cooled DBR 600 illustrated in FIG. 6B as applicable. The similar elements in cyclonic flow, liquid cooled DBR 600, therefore, may share the description provided for the corresponding element described above in relation to cyclonic flow, liquid cooled DBR 100 and the various components described with respect to FIGS. 3A-3F, and as a result, the description references prior discussion of similar functionality.

As illustrated, cyclonic flow, liquid cooled DBR 600 includes a spiral resistor structure 618 positioned within a housing 610. In this embodiment, spiral resistor structure 618 includes a first helical shaped resistor coil 616A, a second helical shaped resistor coil 616B, and a third helical shaped resistor coil 616C. A first end of spiral resistor structure 618 is connected to and secured in place by retention cover 620 and a second end of spiral resistor structure 618 is connected to and secured in place by a combination of base cover 622 and support ring 624. Inlet port 628 is defined on a surface of housing 610 in a location near retention cover 620 and outlet port 630 is defined on a bottom surface of base cover 622. Inlet port 628 is configured to receive and route a cooling liquid and/or gaseous cooling mixture into housing 610. The cooling liquid and/or gaseous cooling mixture is circulated around spiral resistor structure 618 to transfer heat from first helical shaped resistor coil 616A, second helical shaped resistor coil 616B, and third helical shaped resistor coil 616C to the cooling liquid and/or gaseous cooling mixture. The cooling liquid and/or gaseous cooling mixture is then routed out of outlet port 630 and discarded or recirculated for additional use.

Cyclonic flow, liquid cooled DBR 600 also includes flow diverter 640. Flow diverter 640 is positioned inside spiral resistor structure 618. Flow diverter 640 is hollow in some embodiments to reduce weight and comprises slots 641A, 641B formed in a base portion of flow diverter 640 to enable the cooling liquid and/or gaseous cooling mixture to be routed out of the outlet port 630. Flow diverter 640 may be formed from any suitable material, such as a light-weight metal material (e.g., aluminum). Inclusion of flow diverter 640 provides added benefits in terms of fluid dynamics for cyclonic flow, liquid cooled DBR 600. For instance, flow diverter 640 may divert flow of the cooling liquid and/or gaseous cooling mixture from pooling and/or collecting within the interior region of spiral resistor structure 618. As such, the cooling liquid and/or gaseous cooling mixture may be controlled around the cyclonic flow channel (e.g., in the space between an outer portion of spiral resistor structure 618 and an inner portion of housing 610) of the cyclonic flow, liquid cooled DBR 600 to more efficiently transfer heat from the helical resistor elements to the cooling liquid and/or gaseous mixture. Such control can improve the overall flow efficiency, reduce or minimize a maximum resistor tube surface temperature, provide a reduction in turbulence, and ensure consistent pressure and velocity along the resistor tubes of spiral resistor structure 618.

In some embodiments, flow diverter 640 may have a smooth outer surface (e.g., the outer surface opposing the inner surface of the spiral resistor structure). In other embodiments, flow diverter 640 may include a plurality of ribs formed on the outer surface. The ribs may include protrusions extending outwards from the outer surface. The ribbed protrusions can have a spiral/helical pattern that aligns with a slope of first helical shaped resistor coil 616A, second helical shaped resistor coil 616B, and third helical shaped resistor coil 616C for the length of the spiral resistor structure 618. As discussed with respect to FIG. 6A, inclusion of the ribs can improve the flow of the cooling liquid and/or gaseous cooling mixture inside the housing 610. For instance, in example DBRs that do not include a flow diverter, it is possible that the cooling liquid and/or gaseous cooling mixture will pool or collect inside the inner space of the spiral resistor structure 618. As such, inclusion of the flow diverter 640 can direct and force the cooling liquid and/or gaseous cooling mixture to flow over the surface area of the helical resistor coils for efficient and effective transfer of heat and recirculation.

FIG. 6C illustrates an enlarged cross-sectional view of the exemplary cyclonic flow, liquid cooled DBR 600 of FIG. 6B, according to an embodiment of the present disclosure. As illustrated, the first helical shaped resistor coil 616A, second helical shaped resistor coil 616B, and third helical shaped resistor coil 616C of the spiral resistor structure 618 are separated by a gap 650 (i.e., not physically touching). For example, gap 650 may be filled with air when the cyclonic flow, liquid cooled DBR 600 is not filled with a fluid, and the gap 650 may be characterized by a uniform spacing. That is, a distance between first helical shaped resistor coil 616A and third helical shaped resistor coil 616C forming gap 650 may be uniform along the length of spiral resistor structure 618 between respective helical shaped resistor coils. As previously described with respect to FIG. 1, use of a uniform spacing between the resistor tube coils further improves the cooling capabilities of cyclonic flow, liquid cooled DBR 600 by increasing the effective surface area of the spiral resistor structure 618. The increased effective surface area enables the cooling liquid and/or gaseous cooling mixture to contact more surface area of (e.g., flow over) the individual resistor tube coils and, thereby, more effectively transfer heat from the resistor tube coils to the cooling liquid and/or gaseous cooling mixture.

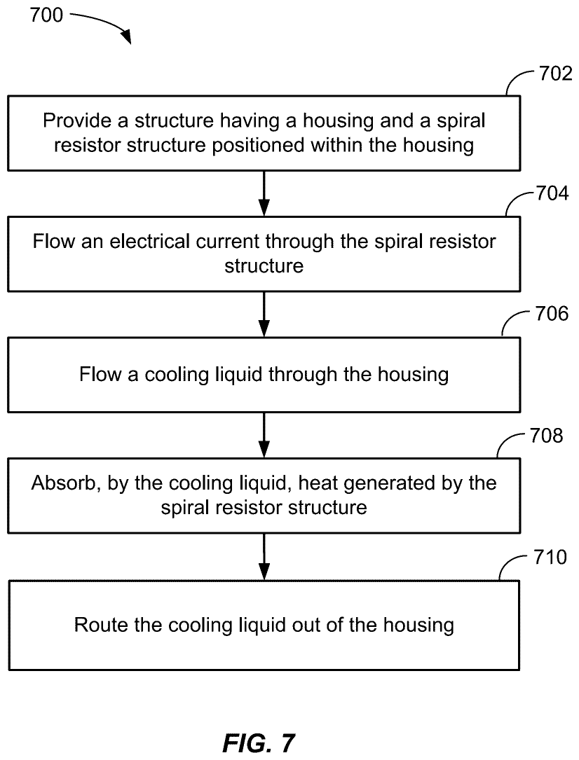

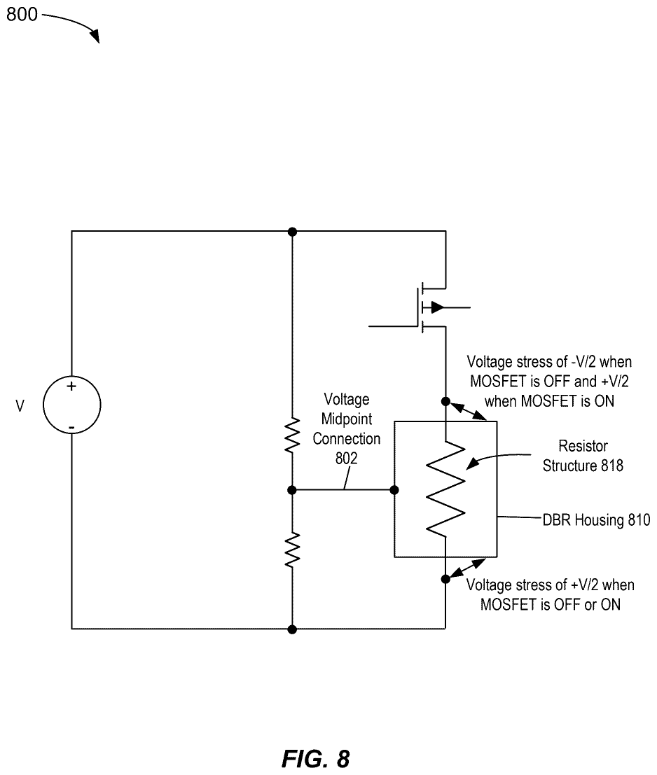

FIG. 7 illustrates an exemplary flowchart illustrating a process 700 of cooling a spiral resistor structure according to an embodiment of the present disclosure. In some implementations, one or more process blocks of FIG. 7 can be performed by an electric machine. In some implementations, one or more process blocks of FIG. 7 can be performed by another device or a group of devices separate from or including the electric machine.

At block 702, process 700 includes providing a structure having a housing and a spiral resistor structure positioned within the housing. The structure can include any of the structures described herein such as the cyclonic flow, liquid cooled DBR 100 describe with respect to FIG. 1, the cyclonic flow, liquid cooled DBR 200 describe with respect to FIG. 2, the cyclonic flow, liquid cooled DBR 600 describe with respect to FIG. 6B having any of the components or features described herein. The structure may be coupled, for example, to an electric motor. The structure may function as a brake resistor to dissipate excess electrical energy generated by the electric motor in the form of heat.

At block 704, process 700 includes flowing an electrical current through the spiral resistor structure. In some examples, the spiral resistor structure may include a single helical resistor element having a single input electrical terminal and a single electrical output terminal. In other examples, more than one helical resistor element may be used to form the spiral resistor structure. For instance, according to one particular example, the spiral resistor structure may include three nested helical resistor elements electrically connected in parallel. Each input electrical terminal may correspond to a single phase of a three-phase electric motor. When the three-phase electric motor generates excess electrical energy, the excess electrical current is flowed through the respective input electrical terminals of the spiral resistor structure and dissipated as heat.

At block 706, process 700 includes flowing a cooling liquid through the housing. The cooling liquid may be flowed into the housing through an inlet port of the housing. In some examples, the cooling liquid may be water (e.g., deionized water, ethylene glycol-water mixtures, propylene glycol-water mixtures, etc.), oil (mineral oil, silicone oil, etc.), hydraulic fluids, fluorinated liquids, liquid-metal coolants, water-based coolants with additives, specialized coolants (e.g., perfluorocarbons or hydrofluoroethers) dielectric fluids, and so on. In some examples, a gaseous mixture may be used as a coolant such as air, nitrogen, gaseous refrigerants, in place of or in combination with a cooling liquid, and so on. Thus, in some examples, a combination of a cooling liquid and gaseous mixture may be used. In some examples, a pump may be utilized to generate sufficient pressure and flow rate to flow the cooling liquid through the housing.

At block 708, process 700 includes absorbing, by the cooling liquid, heat generated by the spiral resistor structure. As electrical current flows through the spiral resistor structure, the individual helical resistor coils of the spiral resistor structure heat up through the principle of resistance. As such, and to prevent overheating and damage to the spiral resistor structure, a cooling liquid is flowed through the housing. In some examples, a different coolant may be used, such as a gaseous coolant mixture. Additionally, and as described above, the spiral resistor structure having improved fluid dynamics by virtue of the helical structure, reduces or eliminates resistive tube hot spots (e.g., allowing for uniform cooling of the spiral resistor structure), allows for closer spacing between individual helical resistor coils, improves heat transfer across helical resistor coils boundaries, and increases heat flow for the same cooling liquid flow rate as compared to conventional designs.

At block 710, process 700 includes routing the cooling liquid out of the housing. The cooling liquid can be expelled out of the housing via an outlet port. In some examples, the cooling liquid can be recirculated through the system (e.g., through the electric motor system) through a closed-loop mechanism. The cooling liquid absorbs heat generated by the spiral resistor structure and the heated liquid is expelled out of the housing, for example, into a heat exchanger, radiator, or other suitable cooling unit where the heated liquid releases the absorbed heat before being recirculated back into the inlet port of the housing. A pump can be used to maintain the flow of the cooling liquid and additional valves and sensors may be utilized to regulate pressure, temperature, and flow rate to optimize performance.

Process 700 can include additional implementations, such as any single implementation or any combination of implementations described below and/or in connection with one or more other processes described elsewhere herein. It should be appreciated that the specific steps illustrated in FIG. 7 provide particular techniques for cooling a spiral resistor structure according to various embodiments of the present disclosure. Other sequences of steps can also be performed according to alternative embodiments. For example, alternative embodiments of the present disclosure can perform the steps outlined above in a different order. Moreover, the individual steps illustrated in FIG. 7 can include multiple sub-steps that can be performed in various sequences as appropriate to the individual step. Although FIG. 7 shows example steps of process 700, in some implementations, process 700 can include additional steps, fewer steps, different steps, or differently arranged steps than those depicted in FIG. 7. Additionally, or alternatively, two or more of the steps of process 700 can be performed in parallel. Furthermore, additional steps can be added or removed depending on the particular applications. One of ordinary skill in the art would recognize many variations, modifications, and alternatives.

The assembled cyclonic flow, liquid cooled DBR 300 described with respect to FIG. 3F (and similarly cyclonic flow, liquid cooled DBR 100 described with respect to FIG. 1, cyclonic flow, liquid cooled DBR 200 described with respect to FIG. 2, and cyclonic flow, liquid cooled DBR 600 described with respect to FIG. 6B) may comprise additional electrical circuitry to further improve the functionality. As illustrated by cyclonic flow, liquid cooled DBR 300 described with respect to FIG. 3F, it is apparent that the electrical terminals (i.e., input electrical terminal 312A-312C and output electrical terminals 314A-314C) enter and exit the housing 340 at opposing ends of the housing. Given this structure, a voltage divider circuit may be used to electrically tie the housing of the DBR (e.g., i.e., housing 340) (and therefore the outer tubing material of each respective helical resistor coil) to a circuit midpoint. In certain embodiments, inclusion of a voltage divider circuit may further improve the capabilities of the DBR. For example, inclusion of the voltage divider circuit can lead to a doubling in terms of voltage capacity for each respective helical resistor coil the cyclonic flow, liquid cooled DBR 300.

FIG. 8 illustrates an exemplary voltage divider circuit 800 according to an embodiment of the present disclosure. Voltage divider circuit 800 may be implemented with the various cyclonic flow, liquid cooled DBR embodiments described herein (i.e., cyclonic flow, liquid cooled DBR 100, cyclonic flow, liquid cooled DBR 200, and so on). As illustrated by FIG. 8, DBR housing 810 having resistor structure 818 (also referred to as the “DBR structure”) is connected to a midpoint via voltage midpoint connection 802. In some embodiments, the midpoint may further be grounded, although this is not always required depending on the particular application and circuit design. In more detail, each helical resistor coil of resistor structure 818 (for example, first helical resistor coil 310A, second helical resistor coil 310B, and third helical resistor coil 310C) is connected or bonded to DBR housing 810 so as to be at the same voltage potential (V) as the DBR housing 810. Additionally, there is a voltage differential between the inner conductor of the resistor coil and the tubing material enclosing the insulator and conductor. The voltage differential between the inner conductor and the tubing material limits the overall voltage capacity of the respective helical resistor coils and therefore the DBR structure. As such, use of voltage divider circuit 800 to connect the DBR housing 810 to a midpoint results in halving the voltage differential of the DBR structure. Due to the halved voltage differential, the overall voltage applied DBR structure can be doubled, thereby increasing the overall voltage limits.

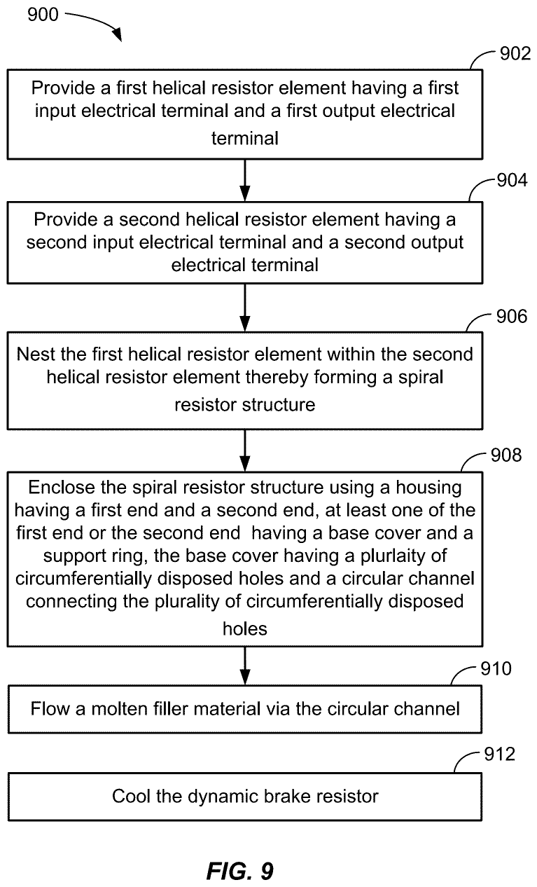

FIG. 9 illustrates an exemplary flowchart illustrating a process 900 of forming a cyclonic flow, liquid cooled DBR according to an embodiment of the present disclosure. The process includes providing a first helical resistor element having a first input electrical terminal and a first output electrical terminal (902), providing a second helical resistor element having a second input electrical terminal and a second output electrical terminal (904), and nesting the first helical resistor element within the second helical resistor element thereby forming a spiral resistor structure (906). The process also includes enclosing the spiral resistor structure using a housing having a first end and a second end, wherein at least one of the first end or the second end comprises a base cover and a support ring, wherein the base cover comprises a plurality of circumferentially disposed holes, and wherein a circular channel connecting the plurality of circumferentially disposed holes is formed around the base cover between the base cover and the support ring (908). The process further includes flowing a molten filler material via the circular channel to distribute the molten filler material into the plurality of circumferentially disposed holes (910) and cooling the DBR to seal base cover to the support ring (912).

In some embodiments, the molten filler material comprises a metallic molten filler material and in other embodiments, the molten filler material comprises a non-metallic molten filler material. The plurality of circumferentially disposed holes can include a plurality of brazing holes and a plurality of riser holes, wherein the first output electrical terminal and the second output electrical terminal extend through the support ring and are accessible outside the DBR, wherein a first riser hole of the plurality of riser holes is positioned between a portion of the first helical resistor element and the support ring, and wherein a second riser hole of the plurality of riser holes is positioned between a portion of the second helical resistor element and the support ring.

Process 900 can include additional implementations, such as any single implementation or any combination of implementations described below and/or in connection with one or more other processes described elsewhere herein. It should be appreciated that the specific steps illustrated in FIG. 9 provide particular techniques for forming a cyclonic flow, liquid cooled DBR according to various embodiments of the present disclosure. Other sequences of steps can also be performed according to alternative embodiments. For example, alternative embodiments of the present disclosure can perform the steps outlined above in a different order. Moreover, the individual steps illustrated in FIG. 9 can include multiple sub-steps that can be performed in various sequences as appropriate to the individual step. Although FIG. 9 shows example steps of process 900, in some implementations, process 900 can include additional steps, fewer steps, different steps, or differently arranged steps than those depicted in FIG. 9. Additionally, or alternatively, two or more of the steps of process 900 can be performed in parallel. Furthermore, additional steps can be added or removed depending on the particular applications. One of ordinary skill in the art would recognize many variations, modifications, and alternatives.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is a resistor structure comprising: a housing including a first end, a second end, and an intermediate portion therebetween, the intermediate portion including a proximal end connected to the first end and a distal end connected to the second end; a first helical resistor element positioned inside the housing and having a first input electrical terminal and a first output electrical terminal; a second helical resistor element nested within the first helical resistor element and having a second input electrical terminal and a second output electrical terminal; a retention cover at least partially enclosing the first end; a base cover at least partially enclosing the second end; a plurality of laterally offset openings in the retention cover, wherein the first input electrical terminal protrudes out of a first laterally offset opening of the plurality of laterally offset openings and the second input electrical terminal protrudes out of a second laterally offset opening of the plurality of laterally offset openings; and a plurality of circumferentially offset openings in the base cover, wherein the first output electrical terminal protrudes out of a first circumferentially offset opening of the plurality of circumferentially offset openings and the second output electrical terminal protrudes out of a second circumferentially offset opening of the plurality of circumferentially offset openings.

Example 2 is the resistor structure of example 1 wherein the first output electrical terminal and the second output electrical terminal are circumferentially offset by 180°.

Example 3 is the resistor structure of example(s) 1-2 wherein the first helical resistor element and the second helical resistor element forms a spiral structure having a central axis running through a center of the spiral structure, wherein the resistor structure further comprises: an inlet port formed in the proximal end of the intermediate portion, the inlet port configured to receive a cooling liquid; an outlet port formed in a bottom side of the base cover, the outlet port configured to expel the cooling liquid; and a flow diverter positioned along the central axis and inside the spiral structure, the flow diverter having a length substantially corresponding to a length of the intermediate portion.

Example 4 is the resistor structure of example(s) 1-3 wherein the outlet port is aligned with the central axis of the spiral structure.

Example 5 is the resistor structure of example(s) 1-4 wherein the flow diverter further comprises a plurality of exit openings positioned in a bottom portion of the flow diverter and configured to allow the cooling liquid to flow out of the outlet port.

Example 6 is the resistor structure of example(s) 1-5 wherein the flow diverter is hollow.

Example 7 is the resistor structure of example(s) 1-6 wherein the first helical resistor element and the second helical resistor element are electrically connected in parallel.

Example 8 is the resistor structure of example(s) 1-7 wherein the first helical resistor element includes a first plurality of resistor coils and wherein the second helical resistor element includes a second plurality of resistor coils, wherein the first plurality of resistor coils and the second plurality of resistor coils are separated by a uniform spacing.

Example 9 is the resistor structure of example(s) 1-8 further comprising a third helical resistor element nested within the first helical resistor element and the second helical resistor element and having a third input electrical terminal and a third output electrical terminal.

Example 10 is the resistor structure of example(s) 1-9 wherein the third input electrical terminal protrudes out of a third laterally offset opening, and wherein the third output electrical terminal protrudes out of a third circumferentially offset opening.

Example 11 is the resistor structure of example(s) 1-10 wherein the first output electrical terminal, the second output electrical terminal, and the third output electrical terminal are circumferentially offset by 120°.

Example 12 is the resistor structure of example(s) 1-11 wherein the resistor structure is electrical coupled to a three-phase electric motor, wherein the first helical resistor element, the second helical resistor element, and the third helical resistor element each corresponds to a single phase of the three-phase electric motor, respectively.

Example 13 is the resistor structure of example(s) 1-12 wherein the first helical resistor element, the second helical resistor element, and the third helical resistor element are electrically connected in parallel.

Example 14 is the resistor structure of example(s) 1-13 further comprising a support ring positioned around the first helical resistor element and the second helical resistor element and coupled to the base cover, the support ring configured to support the first output electrical terminal protruding out of the first circumferentially offset opening and the second output electrical terminal protruding out of the second circumferentially offset opening.

Example 15 is a method of cooling a spiral resistor structure, the method comprising: providing a structure including: a housing having an inlet port on a side portion of the housing and an outlet port on a bottom portion of the housing; a first helical resistor element positioned inside the housing and having a first input electrical terminal and a first output electrical terminal; and a second helical resistor element positioned inside the housing and nested inside the first helical resistor element to thereby form the spiral resistor structure, the second helical resistor element having a second input electrical terminal and a second output electrical terminal; flowing a first electrical current through the first input electrical terminal to the first output electrical terminal; flowing a second electrical current through the second input electrical terminal to the second output electrical terminal; flowing a cooling liquid into the housing through the inlet port; absorbing, by the cooling liquid, heat generated by the spiral resistor structure; and routing the cooling liquid out of the housing through the outlet port.

Example 16 is the method of example 15 further comprising circulating the cooling liquid around a cyclonic flow channel formed in a space between an outer portion of the spiral resistor structure and an inner sidewall portion of the housing.

Example 17 is the method of example(s) 15-16 wherein a central axis is defined through a center of the spiral resistor structure, and wherein the method further comprises increasing a heat transfer between the spiral resistor structure and the cooling liquid using a flow diverter positioned along the central axis.

Example 18 is the method of example(s) 15-17 wherein the first helical resistor element includes a first plurality of resistor coils, wherein the second helical resistor element includes a second plurality of resistor coils, and wherein the first plurality of resistor coils and the second plurality of resistor coils are separated by a uniform spacing.

Example 19 is the method of example(s) 15-18 wherein the cooling liquid comprises water.

Example 20 is the method of example(s) 15-19 wherein the first helical resistor element and the second helical resistor element are electrically connected in parallel.

Example 21 is a resistor structure comprising: a housing including a first end, a second end, and an intermediate portion therebetween, the intermediate portion including a proximal end connected to the first end and a distal end connected to the second end; a first helical resistor element positioned inside the housing and having a first input electrical terminal and a first output electrical terminal; a retention cover at least partially enclosing the first end; a base cover at least partially enclosing the second end; a first opening in the retention cover, wherein the first input electrical terminal protrudes axially out of the first opening; and a second opening in the base cover, wherein the first output electrical terminal protrudes tangentially out of the second opening.

Example 22 is a method of forming a dynamic brake resistor (DBR), the method comprising: providing a first helical resistor element having a first input electrical terminal and a first output electrical terminal; providing a second helical resistor element having a second input electrical terminal and a second output electrical terminal; nesting the first helical resistor element within the second helical resistor element thereby forming a spiral resistor structure; enclosing the spiral resistor structure using a housing having a first end and a second end, wherein at least one of the first end or the second end comprises a base cover and a support ring, wherein the base cover comprises a plurality of circumferentially disposed holes, and wherein a circular channel connecting the plurality of circumferentially disposed holes is formed around the base cover between the base cover and the support ring; flowing a molten filler material via the circular channel to distribute the molten filler material into the plurality of circumferentially disposed holes; and cooling the DBR to seal base cover to the support ring.

Example 23 is the method of example 22, wherein the molten filler material comprises a metallic molten filler material.

Example 24 is the method of example 22, wherein the molten filler material comprises a non-metallic molten filler material.

Example 25 is the method of example(s) 22-24, wherein the plurality of circumferentially disposed holes comprises a plurality of brazing holes and a plurality of riser holes, wherein the first output electrical terminal and the second output electrical terminal extend through the support ring and are accessible outside the DBR, wherein a first riser hole of the plurality of riser holes is positioned between a portion of the first helical resistor element and the support ring, and wherein a second riser hole of the plurality of riser holes is positioned between a portion of the second helical resistor element and the support ring.

The above description of exemplary embodiments of the disclosure has been presented for the purposes of illustration and description. It is not intended to be exhaustive or to limit the disclosure to the precise form described, and many modifications and variations are possible in light of the teaching above. The embodiments were chosen and described in order to best explain the principles of the disclosure and its practical applications to thereby enable others skilled in the art to best utilize the disclosure in various embodiments and with various modifications as are suited to the particular use contemplated.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the disclosure. Also, a number of steps may be undertaken before, during, or after the above elements are considered.

What is claimed is:

1. A resistor structure comprising:
a housing including a first end, a second end, and an intermediate portion therebetween, the intermediate portion including a proximal end connected to the first end and a distal end connected to the second end;
a first helical resistor element positioned inside the housing and having a first input electrical terminal and a first output electrical terminal;
a second helical resistor element nested within the first helical resistor element and having a second input electrical terminal and a second output electrical terminal;
a retention cover at least partially enclosing the first end;
a base cover at least partially enclosing the second end;
a plurality of laterally offset openings in the retention cover, wherein the first input electrical terminal protrudes out of a first laterally offset opening of the plurality of laterally offset openings and the second input electrical terminal protrudes out of a second laterally offset opening of the plurality of laterally offset openings; and
a plurality of circumferentially offset openings in the base cover, wherein the first output electrical terminal protrudes out of a first circumferentially offset opening of the plurality of circumferentially offset openings and the second output electrical terminal protrudes out of a second circumferentially offset opening of the plurality of circumferentially offset openings.

2. The resistor structure of claim 1 wherein the first output electrical terminal and the second output electrical terminal are circumferentially offset by 180°.

3. The resistor structure of claim 1 wherein the first helical resistor element and the second helical resistor element forms a spiral structure having a central axis running through a center of the spiral structure, wherein the resistor structure further comprises:
an inlet port formed in the proximal end of the intermediate portion, the inlet port configured to receive a cooling liquid;
an outlet port formed in a bottom side of the base cover, the outlet port configured to expel the cooling liquid; and
a flow diverter positioned along the central axis and inside the spiral structure, the flow diverter having a length substantially corresponding to a length of the intermediate portion.

4. The resistor structure of claim 3 wherein the outlet port is aligned with the central axis of the spiral structure.

5. The resistor structure of claim 3 wherein the flow diverter further comprises a plurality of exit openings positioned in a bottom portion of the flow diverter and configured to allow the cooling liquid to flow out of the outlet port.

6. The resistor structure of claim 3 wherein the flow diverter is hollow.

7. The resistor structure of claim 1 wherein the first helical resistor element and the second helical resistor element are electrically connected in parallel.

8. The resistor structure of claim 1 wherein the first helical resistor element includes a first plurality of resistor coils and wherein the second helical resistor element includes a second plurality of resistor coils, wherein the first plurality of resistor coils and the second plurality of resistor coils are separated by a uniform spacing.

9. The resistor structure of claim 1 further comprising a third helical resistor element nested within the first helical resistor element and the second helical resistor element and having a third input electrical terminal and a third output electrical terminal.

10. The resistor structure of claim 9 wherein the third input electrical terminal protrudes out of a third laterally offset opening, and wherein the third output electrical terminal protrudes out of a third circumferentially offset opening.

11. The resistor structure of claim 9 wherein the first output electrical terminal, the second output electrical terminal, and the third output electrical terminal are circumferentially offset by 120°.

12. The resistor structure of claim 9 wherein the resistor structure is electrical coupled to a three-phase electric motor, wherein the first helical resistor element, the second helical resistor element, and the third helical resistor element each corresponds to a single phase of the three-phase electric motor, respectively.

13. The resistor structure of claim 9 wherein the first helical resistor element, the second helical resistor element, and the third helical resistor element are electrically connected in parallel.

14. The resistor structure of claim 1 further comprising a support ring positioned around the first helical resistor element and the second helical resistor element and coupled to the base cover, the support ring configured to support the first output electrical terminal protruding out of the first circumferentially offset opening and the second output electrical terminal protruding out of the second circumferentially offset opening.

15. A method of cooling a spiral resistor structure, the method comprising:
providing a structure including:
a housing having an inlet port on a side portion of the housing and an outlet port on a bottom portion of the housing;
a first helical resistor element positioned inside the housing and having a first input electrical terminal and a first output electrical terminal; and
a second helical resistor element positioned inside the housing and nested inside the first helical resistor element to thereby form the spiral resistor structure, the second helical resistor element having a second input electrical terminal and a second output electrical terminal;
flowing a first electrical current through the first input electrical terminal to the first output electrical terminal;
flowing a second electrical current through the second input electrical terminal to the second output electrical terminal;
flowing a cooling liquid into the housing through the inlet port;
absorbing, by the cooling liquid, heat generated by the spiral resistor structure; and
routing the cooling liquid out of the housing through the outlet port.

16. The method of claim 15 further comprising:
circulating the cooling liquid around a first cyclonic flow channel formed in a first space between an outer portion of the spiral resistor structure and an inner sidewall portion of the housing; and
circulating the cooling liquid around a second cyclonic flow channel formed in a second space defined within a cavity of the spiral resistor structure, wherein the cooling liquid comprises water.

17. The method of claim 16 wherein a central axis is defined through a center of the spiral resistor structure, and wherein the method further comprises increasing a heat transfer between the spiral resistor structure and the cooling liquid using a flow diverter positioned along the central axis, wherein the flow diverter adjusts flow of the cooling liquid within the cavity to divert the cooling liquid in a direction toward an inner portion of the spiral resistor structure.

18. The method of claim 15 wherein the first helical resistor element includes a first plurality of resistor coils, wherein the second helical resistor element includes a second plurality of resistor coils, and wherein the first plurality of resistor coils and the second plurality of resistor coils are separated by a uniform spacing.

19. The method of claim 15 wherein the first helical resistor element and the second helical resistor element are electrically connected in parallel.

20. A resistor structure comprising:
a housing including a first end, a second end, and an intermediate portion therebetween, the intermediate portion including a proximal end connected to the first end and a distal end connected to the second end;
a first helical resistor element positioned inside the housing and having a first input electrical terminal and a first output electrical terminal;
a retention cover at least partially enclosing the first end;
a base cover at least partially enclosing the second end;
a first opening in the retention cover, wherein the first input electrical terminal protrudes axially out of the first opening; and
a second opening in the base cover, wherein the first output electrical terminal protrudes tangentially out of the second opening.
